(19) United States
(12) Patent Application Publication
(10) Pub. No.: US 2026/0098929 A1
(43) Pub. Date: Apr. 9, 2026

(54) METHODS AND SYSTEMS FOR ANALOG-DOMAIN JOINT COMMUNICATION AND SENSING

(71) Applicant: Huawei Technologies Co., Ltd., Shenzhen (CN)

(72) Inventors: Shahram Shahsavari, Ottawa (CA); Alireza Bayesteh, Brossard (CA); Jianglei Ma, Ottawa (CA); Wen Tong, Ottawa (CA)

(21) Appl. No.: 19/391,546

(22) Filed: Nov. 17, 2025

Related U.S. Application Data
(63) Continuation of application No. PCT/CN2023/094933, filed on May 18, 2023.

(51) Int. Cl. G01S 5/02; H04L 27/12

(52) U.S. Cl. CPC G01S 5/0268; H04L 27/12

(57) ABSTRACT

In some aspects of the present application, through the use of radio frequency (RF) analog first sensing signals, a transmitter (TX) may communicate side information to a receiver (RX), thereby allowing the RX to self-determine its position. Indeed, the side information may be mapped to a starting frequency of a linearly frequency modulated (LFM) RF first sensing signal using a continuous function. The continuous function may be linear or non-linear. In other aspects of the present application, through the use of RF analog second sensing signals, the RX may communicate sensing signal measurement information to the TX, thereby allowing the TX to determine aspects (like the position) of the RX. Indeed, a given measurement value may be mapped to a starting frequency of an LFM RF second sensing signal using a continuous function. The continuous function may be linear or non-linear.

### CROSS-REFERENCE TO RELATED APPLICATION

The present application is continuation of International Application No. PCT/CN2023/094933, entitled “METHODS AND SYSTEMS FOR ANALOG-DOMAIN JOINT COMMUNICATION AND SENSING” and filed on May 18, 2023, the disclosure of which is hereby incorporated by reference in its entirety.

### TECHNICAL FIELD

The present disclosure relates, generally, to wireless mobile communications and, in particular embodiments, to sensing applications and, more particularly, to analog-domain joint communication and sensing.

### BACKGROUND

Communication nodes that demonstrate low power consumption and low operational complexity are expected to be especially welcome in future wireless systems. Indeed, it is anticipated that many communication nodes with low power budgets and low computation capabilities will find a place in future networks. In such cases, radio frequency (RF) analog operations are expected to be generally preferred over digital operations. Digital processing, associated with digital operations, may demonstrate higher power consumption and higher complexity when compared to analog operations, especially at relatively high frequencies.

It is further expected that sensing will be an important service in future systems and that a large number of low-capability and low-power nodes will be involved in the sensing. Sensing has many variations, with positioning being the most well-known variation, although any information obtained from any device can be considered sensing. Examples of information obtained from sensing include pose (position vector, velocity vector, orientation, heading) and time reference. Generally speaking, sensing estimation requires two ingredients. The first ingredient is measurement results, such as angle measurement results or range measurement results, which are both typically used in positioning. The second ingredient is sensing side information (also known, more simply, as “side information”), which is scenario dependent. For example, in a case of finding a position of a node, it is helpful that a position of a transmitter (TX position) of a sensing signal is known. In this example, TX position is sensing side information useful for sensing estimation. The reason that TX position is useful is that the measurement results, obtained at the receiver (RX) end of the communication channel, are interpreted in view of the TX position. It follows that determining RX position, either at the RX or at the TX, involves using the measurement results (angle measurement results and range measurement results, both with respect to TX position) in combination with the TX position. In this example, the TX and the RX are arbitrary nodes in the network.

### SUMMARY

In some aspects of the present application, through the use of RF analog sensing signals, a TX may communicate side information to an RX, thereby allowing the RX to self-determine its position. Indeed, the side information may be mapped to a starting frequency of a linearly frequency modulated (LFM) RF first sensing signal using a continuous function. The continuous function may be linear or non-linear. In other aspects of the present application, through the use of RF analog sensing signals, the RX may communicate sensing signal measurement information to the TX, thereby allowing the TX to determine the position of the RX. Indeed, a given measurement value may be mapped to a starting frequency of an LFM RF second sensing signal using a continuous function. The continuous function may be linear or non-linear.

It is known to use a digital baseband domain for sensing feedforward signals and/or sensing feedback signals. The use of digital baseband domain approaches may be shown to be associated with power consumption and operational complexity. Implementing these known approaches may involve use of extra hardware and operations, which may also be associated with complexity. Other known approaches use a radio frequency analog domain for sensing signals. However, it may be shown that the other known approaches are poorly adapted for carrying high-precision continuous information values, such as measurement results or sensing side information.

Aspects of the present application relate to use of radio frequency analog domain for sensing signals in a manner that may be shown to be adaptable to carrying relatively high-precision continuous information values. Some aspects of the present application may be shown to enable the reporting of sensing measurements (e.g., range/angle) from RX to TX with a relatively high precision by embedding the sensing measurements in a signal in the analog domain. Other aspects of the present application may be shown to enable transmission of side information (e.g., TX position) from TX to RX with a relatively high precision by embedding the side information in a signal in the analog domain. Aspects of the present application may be shown to enable relatively low-latency and relatively low-complexity positioning services at the RX with relatively low power consumption. Aspects of the present application may be shown to enable relatively low-complexity synchronization at the RX with relatively low power consumption.

According to an aspect of the present disclosure, there is provided a method. The method includes receiving a mapping function and transmitting a linearly frequency modulated sensing signal, the linearly frequency modulated sensing signal obtained by mapping, based on the mapping function, sensing data to a starting frequency of the linearly frequency modulated sensing signal.

According to an aspect of the present disclosure, there is provided a method. The method includes receiving a first sensing signal and transmitting a linearly frequency modulated (LFM) radio frequency (RF) second sensing signal, the LFM RF second sensing signal having a second sensing signal starting frequency. The second sensing signal starting frequency may be obtained by obtaining, by performing measurements of the first sensing signal, a plurality of measurement results, the plurality of measurement results including a measurement value and providing the measurement value as an argument to a continuous mapping of measurement values to starting frequencies, where the second sensing signal starting frequency is output from the continuous mapping of measurement values to starting frequencies.

According to an aspect of the present disclosure, there is provided a method of obtaining, at a sensing signal transmitter, a measurement value from a second sensing signal. The method includes transmitting a first sensing signal, receiving, from a receiver of the first sensing signal, a linearly frequency modulated (LFM) radio frequency (RF) second sensing signal, obtaining, based on measurements of the LFM RF second sensing signal, an estimated second sensing signal starting frequency and extracting an estimated measurement value by providing the estimated second sensing signal starting frequency as an argument to an inverse of a continuous mapping of measurement values to starting frequencies.

According to an aspect of the present disclosure, there is provided a method. The method includes receiving, from a transmitter, a linearly frequency modulated (LFM) radio frequency (RF) first sensing signal, the LFM RF first sensing signal having a first sensing signal starting frequency, obtaining, by performing measurements of the LFM RF first sensing signal, a plurality of measurement results, processing the plurality of measurement results to obtain an estimated first sensing signal starting frequency, extracting estimated side information by providing the estimated first sensing signal starting frequency as an argument to an inverse of a continuous mapping of side information to starting frequencies and estimating, based on the estimated side information and the plurality of measurement results, sensing parameters.

According to an aspect of the present disclosure, there is provided a method. The method includes transmitting a linearly frequency modulated (LFM) radio frequency (RF) first sensing signal, the LFM RF first sensing signal having a first sensing signal starting frequency. The first sensing signal starting frequency may be obtained by obtaining side information and providing the side information as an argument to a continuous mapping of side information to starting frequencies, where the first sensing signal starting frequency is output from the continuous mapping.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a transmitter and a receiver and communication related to a first scenario;

FIG. 7 illustrates a transmitter and a receiver and communication related to a second scenario;

FIG. 8 illustrates a manner in which a first example linearly frequency modulated (LFM) sensing signal may be constructed, in accordance with aspects of the present application;

FIG. 9 illustrates a manner in which a second example LFM sensing signal may be constructed, in accordance with aspects of the present application;

FIG. 10 illustrates a table that provides detail for the terms “sensing data” and “RF signal” for use in the scenario depicted in FIG. 6 and in the scenario depicted in FIG. 7;

FIG. 11 illustrates an analog mapping implemented as a triangular waveform;

FIG. 12 illustrates, in a signal flow diagram, steps in a method for use in the scenario depicted in FIG. 6, in accordance with aspects of the present application;

FIG. 13 illustrates, in a signal flow diagram, steps in a method for use in the scenario depicted in FIG. 7, in accordance with aspects of the present application;

FIG. 14 illustrates, in a signal flow diagram, steps in a method for use in a hybrid scenario related to the scenario depicted in FIG. 6, in accordance with aspects of the present application;

FIG. 15 graphically illustrates an example candidate analog mapping as a linear function, in accordance with aspects of the present application;

FIG. 16 graphically illustrates the example candidate analog mapping as a non-linear function, in accordance with aspects of the present application;

FIG. 17 illustrates a transmitter and a receiver and communication related to a scenario for low-latency receiver positioning, in accordance with aspects of the present application;

FIG. 18 illustrates a feedforward sensing signal implemented as two triangular waveforms, in accordance with aspects of the present application; and

FIG. 19 illustrates a graphical representation of a two-level hierarchical mapping scheme, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

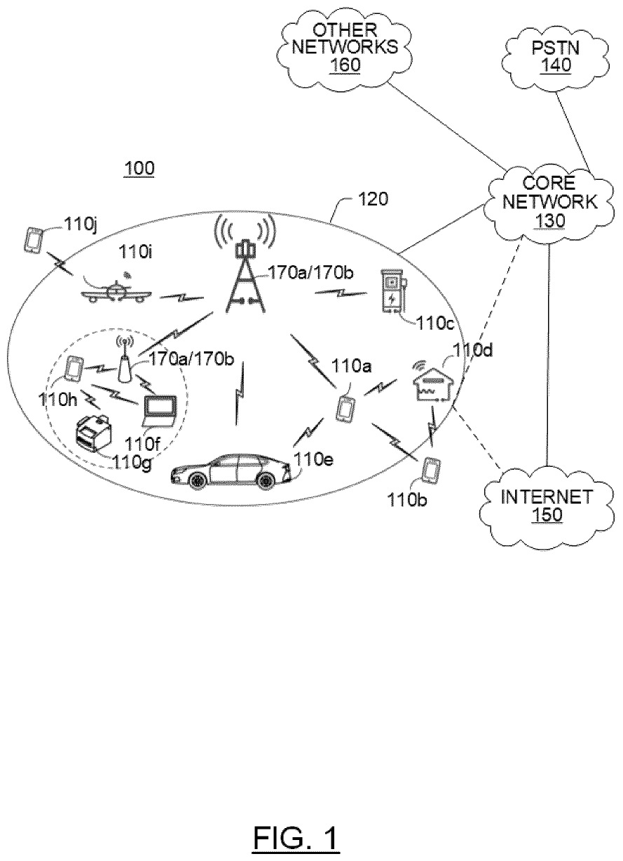

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

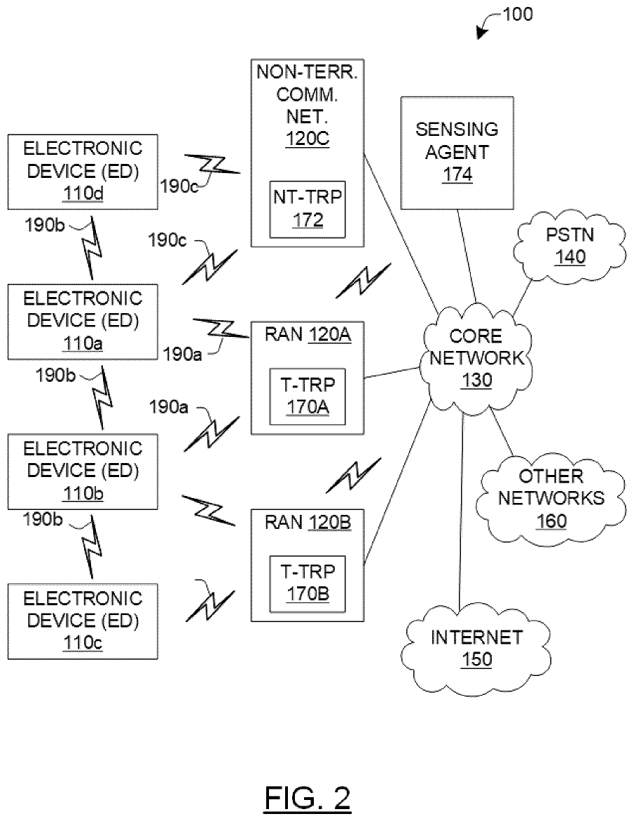

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 1900 can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANS 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

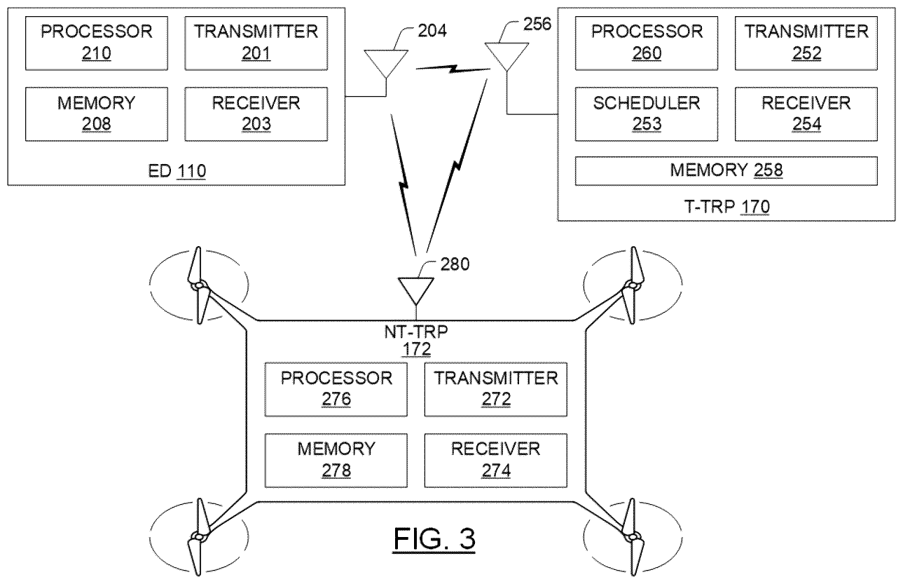

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

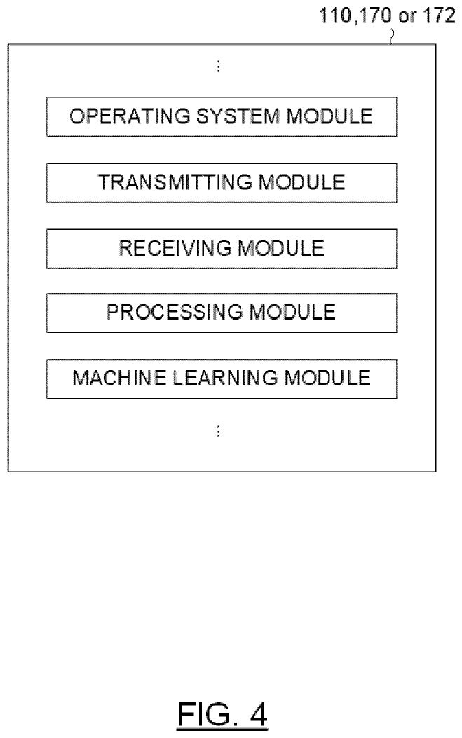

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

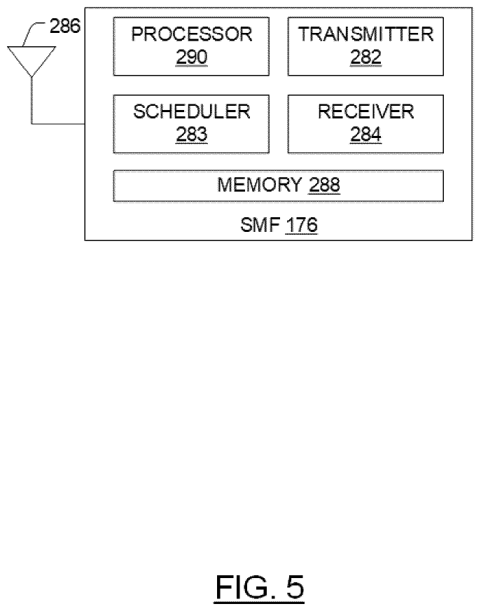

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp,” orthogonal frequency-division multiplexing (OFDM), cyclic prefix (CP)-OFDM, and Discrete Fourier Transform spread (DFT-s)-OFDM.

In an embodiment, the sensing signal is a linearly frequency modulated (LFM) signal with bandwidth B and time duration T. Some LFM signals may be called chirp signals. Linear chirp signals are generally known from use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}),

$$α = \frac{{f}_{chirp 1} - {f}_{chirp 0}}{{t}_{chirp 1} - {t}_{chirp 0}}$$

is defined as the chirp rate. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

Typically, in scenarios similar to the positioning example described hereinbefore, the RX has the measurement results and the TX has the sensing side information. It follows that, to allow for sensing parameter estimation to be performed at the TX, it may be considered that the RX should provide, to the TX, the measurement results. Alternatively, to allow for sensing parameter estimation to be performed at the RX, it may be considered that the TX should provide, to the RX, the side information.

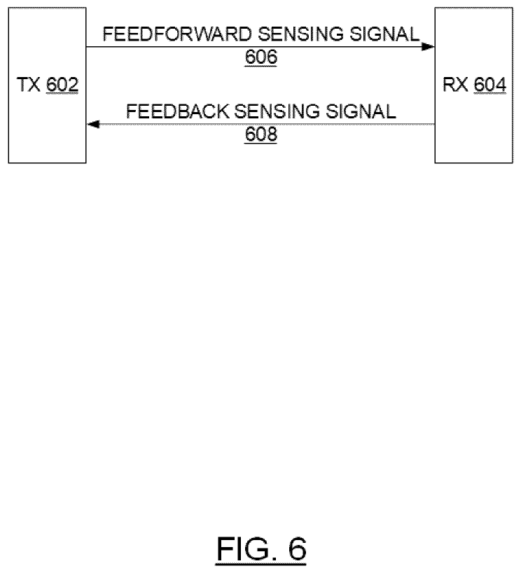

FIG. 6 illustrates a TX 602 and an RX 604. More particularly, FIG. 6 illustrates communication related to a first scenario. In the first scenario, the TX 602 transmits a first sensing signal 606. In some embodiments, the first sensing signal 606 may be implemented as a positioning reference signal (PRS). Upon receipt of the first sensing signal 606, the RX 604 obtains measurement results. The RX 604 then transmits a second sensing signal 608, to the TX 602, where the second sensing signal 608 includes a measurement value so that the TX 602 may perform sensing estimation.

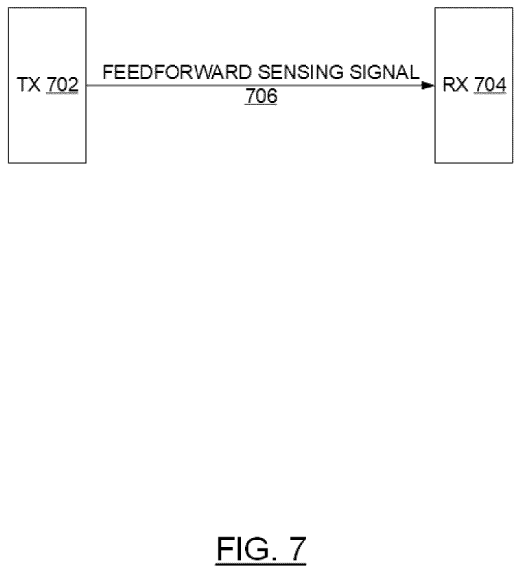

FIG. 7 illustrates a TX 702 and an RX 704. More particularly, FIG. 7 illustrates communication related to a second scenario. In the second scenario, the TX 702 transmits a first sensing signal 706. The TX 702 includes, in the first sensing signal 706, side information. That is, The TX 702 transmits side information so that the RX 704, upon receipt of the first sensing signal 706 and subsequent obtaining of measurement results, may perform sensing parameter estimation.

The first scenario, illustrated in FIG. 6, is known. Indeed, the first scenario may be found in 5G NR standards documentation. For example, it has been discussed, in 5G NR standardization, that a TRP (e.g., the TX 602) may transmit the first sensing signal 606 in a downlink (DL) direction, so that a UE 110 (e.g., the RX 604) may obtain measurement results. The UE 110 may transmit the measurement results included in the sensing signal 608. The UE 110 may transmit the second sensing signal 608 to the TRP 170 and/or one or more other elements of the network to which the TRP 170 and the UEs 110 belong. In some embodiments, the first sensing signal, transmitted by the TX 602, is called a “feedforward” sensing signal and the second sensing signal, transmitted by the RX 604, is called a “feedback” sensing signal. Next, an element of the network, say, the SMF 176, may determine the position of the UE 110. When determining the position of the UE 110, the SMF 176 may use the measurement results and the side information. The side information may be considered to have been made available, by the TRP 170 to the SMF 176, at a network level. It should be noted that, in 5G NR, the UE 110 generates a digital baseband feedback signal. It follows that providing, to the SMF 176, the obtained measurement results involves the UE 110 carrying out processing operations in the digital baseband domain.

For a version of the first scenario (FIG. 6), a chirp signal, defined as e^{j2πft+jπαt}^{²}, may be used by the RX 604 to transmit the second sensing signal 608. In part, the RX 604 may embed, in the starting frequency (i.e., f) of the chirp signal, an RX node ID associated with the RX 604. Notably, the RX node ID is specific information. The values for the RX node ID are discrete. Looking forward, however, there may be a desire to provide, to the TX 602, some values that are high-precision, continuous values, such as range and angle.

For a version of the second scenario (FIG. 7), a chirp signal, defined as e^{j2πf(i,j) t+jπαt}^{²}, may be used by the TX 702 to transmit the first sensing signal 706, where f(i,j) denotes a starting frequency for the transmitted chirp signal. Notably, f(i,j) may be used to carry an indication of a quantized TX position. That is, the TX 702 may embed, in the starting frequency of a chirp-signal-based first sensing signal 706, a quantized version of its position, i.e., a quantized representation of the position of the TX 702, based on a discrete grid (not shown) formed on the network area. Upon receipt of the first sensing signal 706, the RX 704 may obtain measurement results for range and angle by measuring the first sensing signal 706. Upon receipt of the first sensing signal 706, the RX 704 may also extract an indication of the position of the TX 702.

More specifically, there may be predefined mapping between each starting frequency among a set of starting frequencies and a discrete position among a set of discrete positions in the grid formed on the network area. Accordingly, the TX 702 may determine which of the starting frequencies is associated with the position of the TX 702 in the grid. The TX 702 may then transmit the side information (TX position) in the first sensing signal 706. The TX 702 transmits a chirp-signal-based first sensing signal 706, e^{j2πnf(i,j)t+jπαt}^{²}, where f(i,j) denotes the starting frequency of the transmitted chirp signal. The chirp-signal-based first sensing signal 706 carries the information of a quantized TX position.

Notably, the values of the different starting frequencies are assumed to be sufficiently far from each other to enable non-ambiguous detection at the RX 704. Further notably, the positioning accuracy may be shown to be restricted by position quantization error. In other words, the RX 704 does not receive an exact position of the TX 702. Rather, the RX 704 receives only a quantized version of the position of the TX 702. The quantization may be shown to have an impact on the accuracy of the position of the TX 702. It may be shown that the overall position accuracy improves in response to reductions in the position quantization error obtained through increases in the density of the grid. Increases in the density of the grid, in turn, are compensated for with use of a larger set of starting frequencies, i.e., increasing the size of the set of f(i,j). Unfortunately, a larger set of starting frequencies may be shown to increase resource overhead.

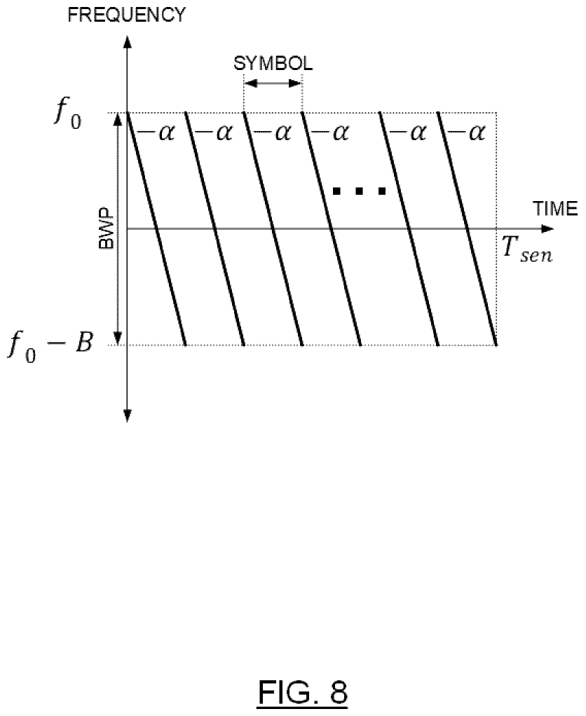

A first example chirp-signal-based first sensing signal may be constructed as illustrated in FIG. 8. The chirp-signal-based sensing signal illustrated in FIG. 8 is a FMCW signal that is formed as a plurality of parallel single chirps multiplexed in the time domain.

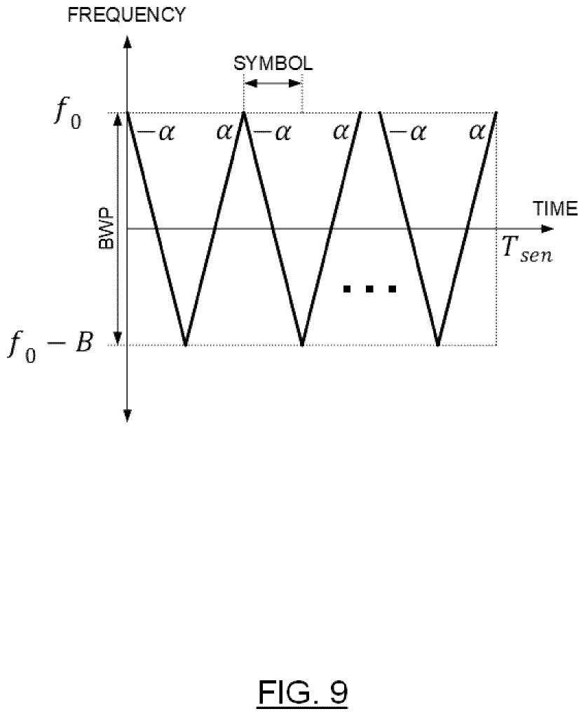

A second example chirp-signal-based first sensing signal may be constructed as illustrated in FIG. 9. The chirp-signal-based first sensing signal illustrated in FIG. 9 may be called a triangular waveform. A triangular waveform may be formed as a plurality of parallel single chirp signals with alternating opposite sign chirp rates.

In overview, aspects of the present application relate to generation and transmission of sensing signals while maintaining operations in the analog domain by using chirp-based RF signals, such as FMCW signals (see FIG. 8) and triangular signals (see FIG. 9). It may be shown that the signals illustrated in FIG. 8 and FIG. 9 facilitate estimating both range and doppler shift.

Aspects of the present application relate to defining a relatively high-precision analog (continuous) mapping between sensing data and an RF signal so that the RF signal can carry data associated with the sensing operation(s).

In the scenario depicted in FIG. 6, the sensing data is a measurement value and RF signal is the second sensing signal 608. Aspects of the present application relate to embedding the measurement value into the second sensing signal 608 using an analog mapping.

In the scenario depicted in FIG. 7, the sensing data is the sensing side information and the RF signal is the first sensing signal 706. The sensing side information may, for example, be position information for the TX 702. Aspects of the present application relate to embedding the side information in the first sensing signal 706 using an analog mapping.

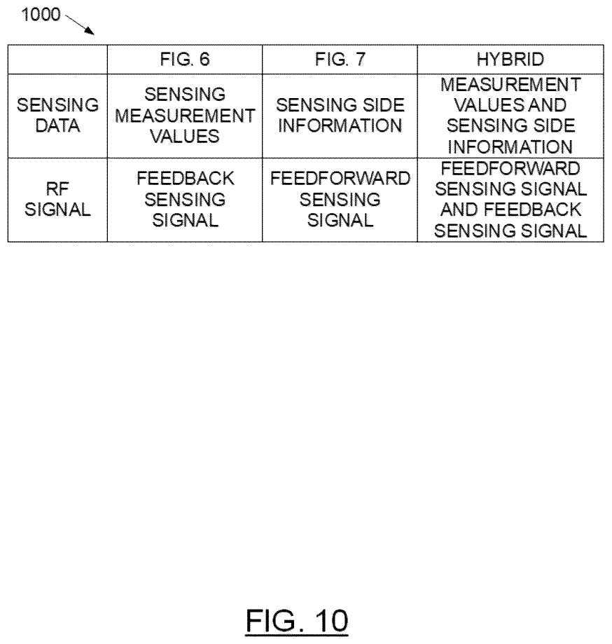

FIG. 10 illustrates a table 1000 that provides detail for the terms “sensing data” and “RF signal” for use in the scenario depicted in FIG. 6 and in the scenario depicted in FIG. 7. The table 1000 of FIG. 10 also includes a hybrid scenario (not illustrated) for a generalized case in which there are feedforward sensing signals (similar to the first sensing signal 606, see FIG. 6) and feedback sensing signals (similar to the second sensing signal 608, see FIG. 6). Notably, in the scenario depicted in FIG. 6, only the second sensing signal 608 carries sensing data. In the hybrid scenario, both the feedforward sensing signals and the feedback sensing signals may be configured to carry some sensing data.

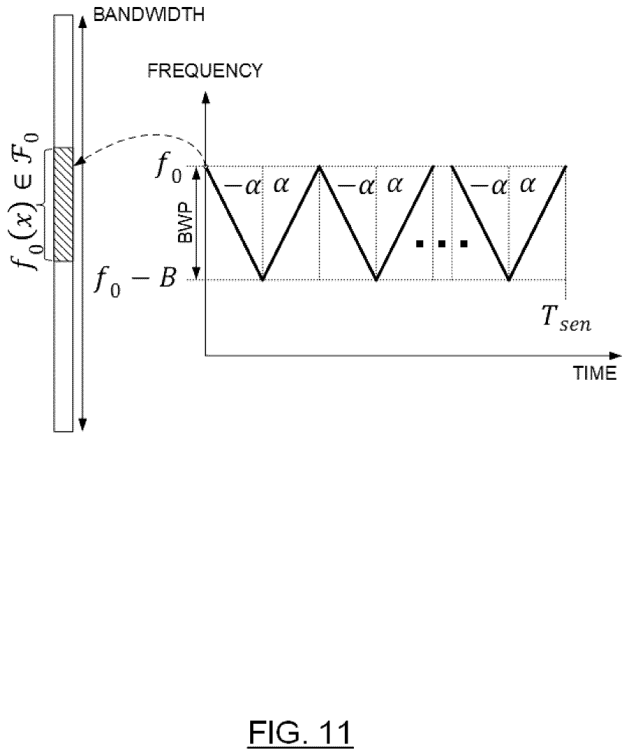

In aspects of the present application, a variable, x, may be defined to represent data. Although various aspects of the present application focus on defining the variable, x, as representative of sensing data, it should be clear to a person of skill in the art that the variable, x, may be representative of any type of data, including communication data. The variable, x, may be understood to have a value that is both continuous and relatively high-precision. An analog mapping, f₀(x), may be defined to map a value of the variable, x, to a starting frequency, f₀, of a triangular waveform illustrated in FIG. 11. Mathematically, xϵ [symbol] →f₀(x)ϵ [symbol] ₀, where [symbol] represents a domain of the data, x, and [symbol] ₀ represents a range of the starting frequency, f₀.

In one example, the analog mapping, f₀(x), may be expressed as a linear function of the form f₀(x)=ax+b, where a and b may be referred to as “mapping coefficients.” Using this analog mapping, f₀(x), the starting frequency of a given sensing signal carries information of the data, x. A receiver of the given sensing signal may extract an estimate, x′, of the data by first obtaining an estimate,

$${f}_{0}^{′} ,$$

of the starting frequency and then using the estimate as an argument in an inverse,

$${f}_{0}^{- 1} ( \cdot ) ,$$

of the analog mapping.

That is,

$${x}^{′} = {f}_{0}^{- 1} ( {f}_{0}^{′} ) .$$

Note that, since the analog mapping, f₀(x), is continuous and analog, the precision of the data, x, is preserved and there is no need for quantization.

Aspects of the present application may be understood to be applicable to a variety of scenarios. Two important examples are the scenario depicted in FIG. 6 and the scenario depicted in FIG. 7. Such scenarios cover many of future sensing applications, such as positioning, synchronization, etc. Notably, it is expected that sensing will be an important service in future (e.g., 6G) systems. Aspects of the present application may be carried out at nodes performing as sensing TX nodes and nodes performing as sensing RX nodes. Aspects of the present application provide new, particular definitions and constructions for the sensing signals in a manner that allows for an exchange of some relatively high-precision data between the TX and the RX.

Aspects of the present application may be shown to be applicable to the scenario depicted in FIG. 6. In the scenario depicted in FIG. 6, the RX 604 performs measurements on the first sensing signal 606 received from the TX 602. Accordingly, the RX 604 obtains measurement results. The RX 604 then transmits the second sensing signals 608, including a measurement value.

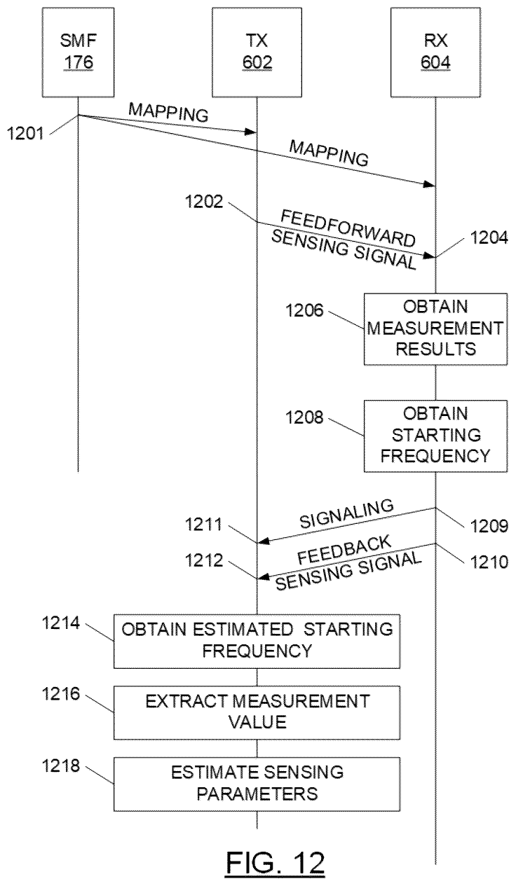

The scenario depicted in FIG. 6 includes both the first sensing signals 606 and the second sensing signals 608. However, only the second sensing signals 608 carry sensing data. The sensing data is the measurement value obtained by the RX 604 on the basis of receiving the first sensing signal 606. A signal flow diagram, which highlights steps in a method for use in the scenario depicted in FIG. 6, is illustrated in FIG. 12.

As background, a network entity, such as the SMF 176, defines an analog mapping from the domain of measurement values (such as range or angle) to the domain of starting frequencies for chirp-based RF sensing signals. Upon defining the mapping, the SMF 176 may share (step 1201), through signaling, the mapping with the TX 602 and the RX 604. This defining (not shown) and sharing (step 1201) may be configured to occur only once or may be configured to occur once in a while.

The TX 602 transmits (step 1202) the first sensing signal 606. In the present scenario, the first sensing signal 606 may be understood to be a typical sensing signal (i.e., the first sensing signal 606 does not carry sensing data). The first sensing signal 606 may be understood to only be used, at the RX 604, as a basis on which to perform sensing such that the RX 604 obtains measurement results.

The RX 604 may receive (step 1204) the first sensing signal 606.

The RX 604 may then perform sensing to, thereby, obtain (step 1206) measurement results.

Using the measurements results, obtained in step 1206, and the mapping received earlier (transmitted, by the SMF 176, in step 1201), the RX 604 may obtain (step 1208) a value for a starting frequency, f₀, for a to-be-transmitted chirp-based RF second sensing signal (see FIG. 11). That is, the RX 604 may provide a measurement value, selected from among the measurements results, as an argument to a continuous mapping, f₀(x), where the starting frequency, f₀, for the to-be-transmitted chirp-based RF second sensing signal is output of the continuous mapping, f₀(x).

The RX 604 may then generate the to-be-transmitted chirp-based RF second sensing signal.

Optionally, the RX 604 may then transmit (step 1209) signaling to the TX 602. The signaling may be used to inform the TX 602 about a type for the measurement that is embedded in the to-be-transmitted chirp-based RF second sensing signal. The signaling may indicate that the measurement value is indicative of a range, an angle of arrival, or some other measurement value. The type-of-measurement signaling may not immediately precede the second sensing signal. This may be the case if, for example, the measurement type was previously configured or agreed-upon. In general, the measurement type may be explicitly indicated in the signaling transmitted at 1209, or may be implicitly indicated by some other configuration or signaling.

The RX 604 may then transmit (step 1210) the chirp-based RF second sensing signal 608.

The TX 602 receives (step 1211) the type-of-measurement signaling.

After the TX 602 has received (step 1212) the second sensing signal 608, the TX 602 may perform measurements to, thereby, obtain (step 1214) an estimated starting frequency,

$${f}_{0}^{′} .$$

The TX 602 may use the estimated starting frequency,

$${f}_{0}^{′} ,$$

as an argument to an inverse,

$${f}_{0}^{- 1} ( \cdot ) ,$$

of the received mapping to, thereby, extract (step 1216) an estimated measurement value with relatively high precision.

The TX 602 may use the measurement value extracted in step 1216 along with side information (such as TX position) available at the TX 602 to estimate (step 1218) sensing parameters.

The obtaining (step 1214) of the estimated starting frequency,

$${f}_{0}^{′} ,$$

based on measurements of a received chirp-based RF second sensing signal 608 may be considered to be equivalent to processing a received chirp-based RF signal to estimate a Doppler shift, f_{D}. The task of processing a received chirp-based RF signal to estimate a Doppler shift is well understood and has many well-known approaches. Consequently, processing a received chirp-based RF second sensing signal to estimate a Doppler shift may be expected to be accomplished with relatively high accuracy.

Aspects of the present application rely upon an assumption that the TX 602 and the RX 604 are stationary. Accordingly, when the RX 604 transmits (step 1210) the second sensing signal 608, it can be assumed that the starting frequency, f₀, of the second sensing signal 608 is not distorted by a further Doppler shift. In other words, the RX 604 creates an artificial Doppler shift when the RX 604 generates the to-be-transmitted chirp-based RF second sensing signal 608 according to the received analog mapping. This artificial Doppler shift carries the information of sensing data. The sensing data, in the scenario depicted in FIG. 6, is the measurement value. In some embodiments, the analog mapping of the measurement values to the starting frequency, f₀, of the second sensing signal 608 may be performed in such a way that, even with reasonable mobility of the RX 604 and/or the TX 602, the estimation error of the measurements is small. This small estimation error means that the mapped starting frequency, f₀, for the majority of measurement values should be much larger than the Doppler value, f_{D}, that is expected to be present due to mobility of the RX 604 and/or the TX 602.

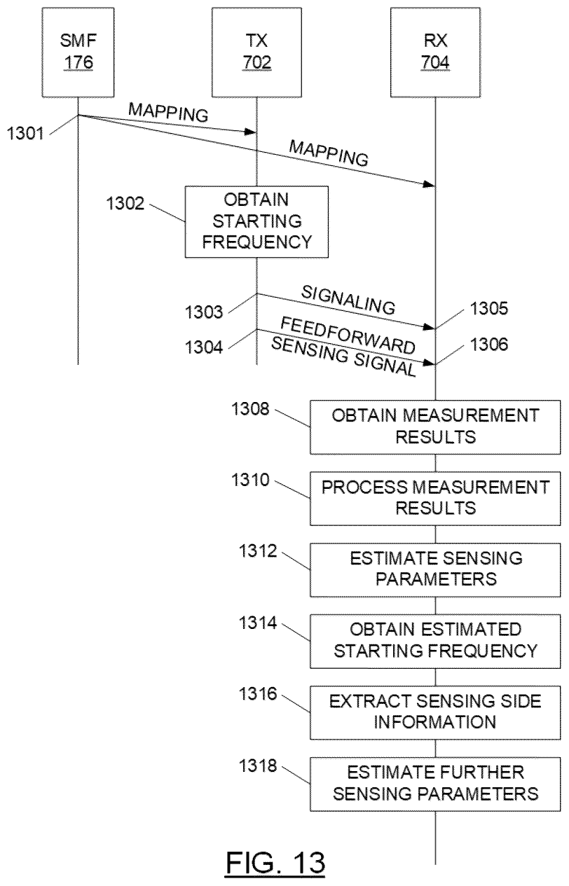

Aspects of the present application may be shown to be applicable to the scenario depicted in FIG. 7. In the scenario depicted in FIG. 7, the TX 702 embeds some side information into the first sensing signal 706 using an analog mapping. Note that there is no second sensing signal in the scenario depicted in FIG. 7. A signal flow diagram, which highlights steps in a method for use in the scenario depicted in FIG. 7, is illustrated in FIG. 13.

As background, a network entity, such as the SMF 176, defines an analog mapping from the domain of sensing side information (such as TX position) to the domain of starting frequencies for chirp-based RF sensing signals. Upon defining the mapping, the SMF 176 may share (step 1301), through signaling, the mapping with the TX 702 and the RX 704. This defining (not shown) and sharing (step 1301) may be configured to occur only once or may be configured to occur once in a while.

Using the side information available at the TX 702 and the received mapping, the TX 702 may obtain (step 1302) a value for a starting frequency, f₀, for a to-be-transmitted chirp-based RF first sensing signal.

Optionally, the TX 702 may then transmit (step 1303) signaling to the RX 704. The signaling may be used to inform the RX 704 about the type of side information that is embedded in the to-be-transmitted chirp-based RF sensing signal. The type of side information signaling may not immediately precede the second sensing signal. This may be the case if, for example, the side information type was previously configured or agreed-upon. In general, the side information type may be explicitly indicated in the signaling transmitted at 1303, or may be implicitly indicated by some other configuration or signaling.

The TX 702 may then generate the to-be-transmitted chirp-based RF sensing signal. The TX 702 may then transmit (step 1304) the chirp-based RF first sensing signal 706. The RX 704 may receive (step 1305) the side-information-type signaling.

Upon receiving (step 1306) the first sensing signal 706, the RX 704 may perform sensing to, thereby, obtain (step 1308) measurement results.

Using the mapping received earlier, the RX 704 may process (step 1310) the measurements results, obtained in step 1308. The processing (step 1310) of the measurements results may allow the RX 704 to estimate (step 1312) a range, i.e., a distance from the TX 702 to the RX 704. The processing (step 1310) of the measurements results may allow the RX 704 to estimate (step 1312) an angle of arrival of the sensing signal received in step 1306. The processing (step 1310) of the measurements results may allow the RX 704 to estimate (step 1312) other sensing parameters. The processing (step 1310) of the measurements results may also allow the RX 704 to obtain (step 1314) an estimate,

$${f}_{0}^{′} ,$$

of the starting frequency of the first sensing signal 706 received in step 1306.

The RX 704 may use the estimated starting frequency,

$${f}_{0}^{′} ,$$

as an argument to an inverse,

$${f}_{0}^{- 1} ( \cdot ) ,$$

of the received mapping to, thereby, extract (step 1316) the sensing side information with relatively high precision.

The RX 704 may use the sensing side information extracted in step 1316, along with the measurement results obtained in step 1308, to estimate (step 1318) further sensing parameters.

The obtaining (step 1314) of the estimated starting frequency,

$${f}_{0}^{′} ,$$

based on measurements of a received chirp-based sensing signal may be considered to be equivalent to processing a received chirp-based RF signal to estimate a Doppler shift. The task of processing a received chirp-based RF signal to estimate a Doppler shift is well understood and has many well-known approaches. Consequently, processing a received chirp-based RF signal to estimate a Doppler shift may be expected to be accomplished with relatively high accuracy.

Aspects of the present application rely upon an assumption that the TX 702 and the RX 704 are stationary. Accordingly, when the TX 702 transmits (step 1304) the first sensing signal 706, it can be assumed that the starting frequency, f₀, of the first sensing signal 706 is not distorted by a Doppler shift. In other words, the TX 702 creates an artificial Doppler shift when the TX 702 generates the to-be-transmitted chirp-based RF first sensing signal according to the received analog mapping. This artificial Doppler shift carries the information of sensing data. The sensing data, in the scenario depicted in FIG. 7, is the sensing side information.

Aspects of the present application may be shown to be applicable to the hybrid scenario related to the scenario depicted in FIG. 6. Recall that the hybrid scenario is more general, since both the first sensing signals and the second sensing signals carry some sensing data. This movement of sensing data in two directions stands in contrast to the scenario wherein only the second sensing signal 608 (see FIG. 6) carries sensing data.

In the hybrid scenario, the SMF 176 may define two analog mappings. A first analog mapping, among the two analog mappings, may be used to map from the domain of measurement values (such as range or angle) to a starting frequency of the chirp-based RF second sensing signal. The first analog mapping may be referred to as a “feedback mapping.” A second analog mapping, among the two analog mappings, may be used to map from the domain of sensing side information (such as TX position) to the starting frequency of the chirp-based RF first sensing signal. The second analog mapping may be referred to as a “feedforward mapping.”

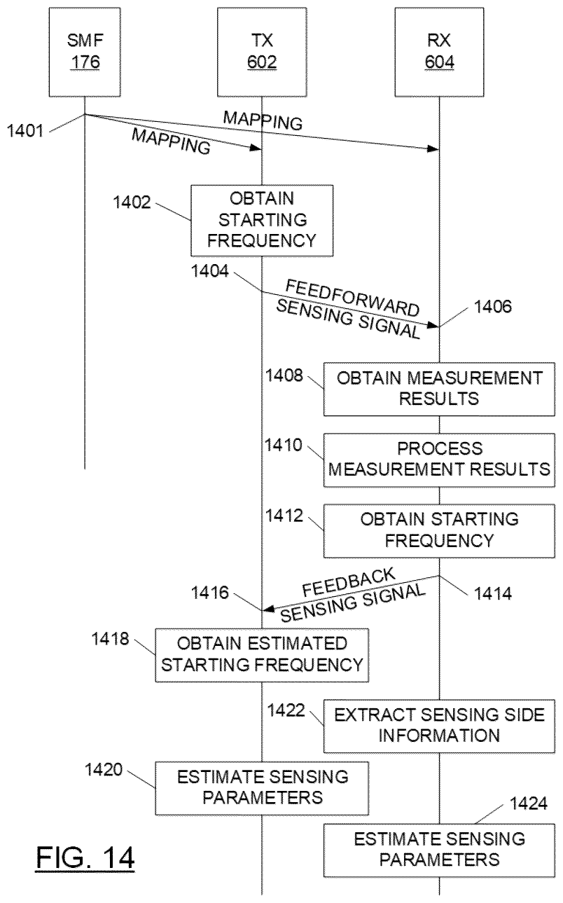

A signal flow diagram, which highlights steps in a method for use in a hybrid scenario related to the scenario depicted in FIG. 6, is illustrated in FIG. 14.

The SMF 176 may share (step 1401), through signaling, the defined feedforward mapping and the defined feedback mapping with the TX 602 and the RX 604. This sharing may happen only once or may happen once in a while.

Using the side information available at the TX 602 and the received mapping, the TX 602 may obtain (step 1402) a value for a starting frequency, f₁, for a to-be-transmitted chirp-based RF first sensing signal.

The TX 602 may then generate the to-be-transmitted chirp-based RF first sensing signal.

The TX 602 may then transmit (step 1404) the chirp-based RF first sensing signal. Although, for clarity purposes, it is not shown, it should be understood that the TX 602 may transmit signaling to the RX 604 to inform the RX 604 about the type of side information that is embedded in the to-be-transmitted chirp-based RF first sensing signal.

The RX 604 may receive (step 1406) the first sensing signal.

Using the mapping received earlier, the RX 604 may process (step 1410) the measurements results, obtained in step 1408. The processing (step 1410) of the measurements results may allow the RX 604 to estimate a range, i.e., a distance from the TX 602 to the RX 604. The processing (step 1410) of the measurements results may allow the RX 604 to estimate an angle of arrival of the first sensing signal received in step 1406. The processing (step 1410) of the measurements results may allow the RX 604 to estimate other sensing parameters. The processing (step 1410) of the measurements results may also allow the RX 604 to obtain an estimate of the starting frequency,

$${f}_{1}^{′} ,$$

of the first sensing signal received in step 1406.

Using the measurements results, obtained in step 1206, and the feedback mapping received earlier, the RX 604 may obtain (step 1412) a value for a starting frequency, f₂, for a to-be-transmitted chirp-based RF second sensing signal.

The RX 604 may then generate the to-be-transmitted chirp-based RF second sensing signal.

The RX 604 may then transmit (step 1414) the chirp-based RF second sensing signal. Although, for clarity purposes, it is not shown, it should be understood that the RX 604 may transmit signaling to the TX 602 to inform the TX 602 about the type of measurement data that is embedded in the to-be-transmitted chirp-based RF second sensing signal.

After the TX 602 has received (step 1416) the feedback sensing signal, the TX 602 may perform measurements to, thereby, obtain (step 1418) an estimate,

$${f}_{2}^{′} ,$$

for the starting frequency of the second sensing signal.

The TX 602 may use the estimated starting frequency,

$${f}_{2}^{′} ,$$

of the feedback sensing signal as an argument to an inverse,

$${f}_{2}^{- 1} ( \cdot ) ,$$

of the received feedback mapping to, thereby, extract a measurement value with relatively high precision. The TX 602 may use the extracted measurement value along with side information available at the TX 602 to estimate (step 1420) sensing parameters.

In the meantime, the RX 604 may use the estimated starting frequency,

$${f}_{1}^{′} ,$$

of the feedforward sensing signal as an argument to an inverse,

$${f}_{1}^{- 1} ( \cdot ) ,$$

of the received feedforward mapping to, thereby, extract (step 1422) the sensing side information with relatively high precision. The RX 604 may use the extracted sensing side information along with measurement values available at the RX 604 to estimate (step 1424) sensing parameters.

The obtaining (step 1412) of the estimated starting frequency,

$${f}_{1}^{′} ,$$

of the first sensing signal and the obtaining (step 1418) of the estimated starting frequency,

$${f}_{2}^{′} ,$$

of the second sensing signal may each be considered to be equivalent to processing a received chirp-based RF signal to estimate a Doppler shift. The task of processing a received chirp-based RF signal to estimate a Doppler shift is well understood and has many well-known approaches. Consequently, processing a received chirp-based RF signal to estimate a Doppler shift may be expected to be accomplished with relatively high accuracy.

Aspects of the present application rely upon an assumption that the TX 602 and the RX 604 are stationary. Accordingly, when the TX 602 transmits (step 1404) the first sensing signal and when the RX 604 transmits (step 1414) the second sensing signal, it can be assumed that the respective starting frequency, f₁ or f₂, is not distorted by a real Doppler shift. As discussed hereinbefore, the TX 602 and the RX 604 each create an artificial Doppler shift when generating to-be-transmitted chirp-based RF sensing signals according to the received analog mapping. The artificial Doppler shift created by the TX 602 carries side information. The artificial Doppler shift created by the RX 604 carries a measurement value. In some embodiments, the analog mapping of the sensing side information to the starting frequency, f₁, at the TX side and the analog mapping of the measurement values to the starting frequency, f₂, may be performed in such a way that, even with reasonable mobility of the RX 604 and/or the TX 602, the estimation error of the measurements is small. This means that the mapped starting frequency, f₁ and/or f₂, for the majority of sensing information to be embedded should be much larger than the Doppler value, f_{D}, due to mobility.

As discussed hereinbefore, aspects of the present application relate to use of an analog mapping. The analog mapping maps sensing data to a starting frequency of a chirp-based RF sensing signal. It should be clear that the chirp-based RF sensing signal could be a feedforward sensing signal or a feedback sensing signal. The sensing data can be of relatively high precision. Examples of sensing data from the foregoing include measurement values, such as range or angle, and side information that may be used when performing sensing estimation.

An important property of a given candidate analog mapping is that the given candidate analog mapping should be invertible. The invertible property may be accomplished using a one-to-one mapping. It may be shown that the importance of the property of invertibility relates to the analog mapping being implemented at a first node, to embed sensing data in a chirp-based RF sensing signal, and an inverse of the analog mapping being implemented at a second node, to extract the sensing data embedded in the chirp-based RF sensing signal.

Consider an example candidate analog mapping achieved using a linear mapping function. The linear mapping function may be shown to map a value of an azimuth angle of arrival measurement, φ, to a starting frequency, f₀. Such a mapping function may be used, for example, when generating a second sensing signal. The azimuth angle of arrival measurement, φ, may be considered to range between 0 and 2π, inclusive. Furthermore, it may be assumed that the starting frequency, f₀, of the chirp-based RF sensing signal may be allowed to take a value in a range between a lower frequency, fₘ, and an upper frequency, f_{M}. The linear mapping function used for the example candidate analog mapping may take the form represented by an expression, f(φ)=aφ+b. The variable a may be represented in terms of the lower frequency, fₘ, and the upper frequency, f_{M}, as

$$a = \frac{{f}_{M} - {f}_{m}}{2 π} .$$

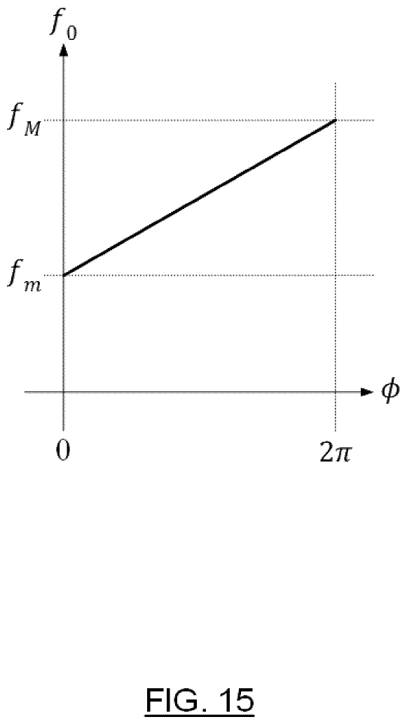

The variable b may be represented in terms of the lower frequency, b=fₘ. FIG. 15 graphically illustrates the example candidate analog mapping.

A receiver of the second sensing signal (say, the TX 602, see FIG. 6 and FIG. 12) may process a received version of the second sensing signal to obtain (step 1214, FIG. 12) an estimated starting frequency,

$${f}_{2}^{′} .$$

The receiver may then extract (step 1216, FIG. 12) an estimated azimuth angle of arrival measurement, φ′, using an inverse of the linear function used for the example candidate analog mapping,

$${ϕ}^{′} = \frac{{f}_{2}^{′} - b}{a} = \frac{2 π ( {f}_{2}^{′} - {f}_{m} )}{{f}_{M} - {f}_{m}} .$$

An increase in the difference, f_{M}−fₘ, may be shown to lead to an increase in accuracy for the estimated azimuth angle of arrival measurement, φ′. However, this increase in accuracy may be considered to come at a cost, in that increases in the difference, f_{M}−fₘ, may be shown to lead to increases in resource overhead associated with sensing.

Consider another example candidate analog mapping, this time achieved using a non-linear mapping function. The non-linear mapping function may be shown to map a value of an x-coordinate of a position of the TX 702, to a starting frequency, f₁. Such a mapping function may be used, for example, when generating a first sensing signal.

The x-coordinate of a position of the TX 702, x, may be considered to range between 0 and x_{M}, inclusive. Furthermore, it may be assumed that the starting frequency, f₁, of the chirp-based RF first sensing signal may be allowed to take a value in a range between a lower frequency, fₘ, and an upper frequency, f_{M}. The non-linear mapping function used for the example candidate analog mapping may take the form represented by an expression,

$${f}_{1} ( x ) = a \sqrt{\frac{x}{b}} + c .$$

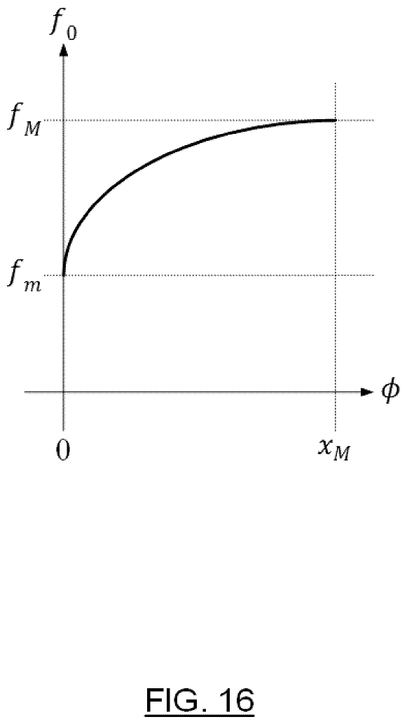

The variable a may be represented in terms of the lower frequency, fₘ, and the upper frequency, f_{M}, as a=f_{M}−fₘ. The variable b may be represented in terms of the upper limit of x, b=x_{M}. The variable c may be represented in terms of the lower frequency, c=fₘ. FIG. 16 graphically illustrates the example candidate analog mapping.

A receiver of the feedforward sensing signal (say, the RX 704, see FIG. 7 and FIG. 13) may process a received version of the feedforward sensing signal to obtain (step 1314, FIG. 13) an estimated starting frequency,

$${f}_{1}^{′} .$$

The receiver may then extract (step 1316, FIG. 13) an estimated x-coordinate of the position of the TX 702, x′, using an inverse of the linear function used for the example candidate analog mapping,

$${x}^{′} = {b ( \frac{{f}_{1}^{′} - c}{a} )}^{2} = {{x}_{M} ( \frac{{f}_{1}^{′} - {f}_{m}}{{f}_{M} - {f}_{m}} )}^{2} .$$

Consider a variable, x, as being representative of sensing data that is to be mapped to a starting frequency, f₁.

It may be shown that larger ranges (i.e., f_{M}−fₘ) for the starting frequency, f₁, are preferred. In practice, estimation errors may be present when a value is found for the estimated starting frequency,

$${f}_{1}^{′} ,$$

at the node that is to extract an estimated value, x′, for the sensing data, x. It may be shown that an error in finding the estimated starting frequency,

$${f}_{0}^{′} ,$$

translates into an error in the estimated value, x′, extracted from the estimated starting frequency,

$${f}_{1}^{′} ,$$

through an application of an inverse mapping.

A comparison may be made of two systems, with a first system configured with a smaller range for a first starting frequency, f₁₀, and a second system configured with a larger range for a second starting frequency, f₂₀. In the first system, a first estimated starting frequency,

$${f}_{10}^{′} ,$$

may be used to find a first estimated value,

$${x}_{1}^{′} .$$

In the second system, a second estimated starting frequency,

$${f}_{20}^{′} ,$$

may be used to find a second estimated value,

$${x}_{2}^{′} .$$

Since the range for the second starting frequency, f₂₀, is larger than the range for the first starting frequency, f₁₀, a same error, Δf′, present when a value is found for each estimated starting frequency,

$${f}_{10}^{′} or {f}_{20}^{′} ,$$

it may be shown that the error present in the second estimated value,

$${x}_{2}^{′} ,$$

is smaller than the error found in the first estimated value,

$${x}_{1}^{′} .$$

Indeed, consider a case wherein a starting frequency, f₀, is related to sensing data, x, by a linear mapping function. Also, consider that the value of the sensing data, x, exists in the range [0, x_{M}]. Note that a slope, s, of a line representative of the linear mapping function may be found from an expression,

$$s = \frac{{f}_{M} - {f}_{m}}{{x}_{M}} .$$

It may be concluded that, if a starting frequency estimation error, Δf₀, is made when finding an estimated starting frequency

$${f}_{0}^{′} ,$$

then a sensing data estimation error,

$$Δ x = \frac{Δ {f}_{0}}{s} ,$$

may be the result. It follows that a larger slope, s, is beneficial in reducing the magnitude of the sensing data estimation error, Δx.

It may be shown that, when comparing two systems, the system with the larger range of starting frequency, f₀, will be associated with a linear mapping function with a larger slope, s. Consequently, the system with the larger range of starting frequency, f₀, will be associated with a sensing data estimation error, Δx, that is smaller when the two systems experience the same starting frequency estimation error, Δf₀. As noted hereinbefore, the benefits of a larger range, f_{M}−fₘ, of starting frequency, f₀, may be considered to come at a cost, in that the larger range, f_{M}−fₘ, is associated with larger resource overhead (larger bandwidth). Consequently, there is tradeoff between performance (accuracy of estimation of x) and resource overhead (bandwidth).

Unlike linear mappings, wherein the slope is constant at every value of the sensing data, x, in non-linear mappings, the slope is dependent upon the value of the sensing data, x. In such scenarios, following a similar argument as presented hereinbefore for the linear mapping function, wherever the slope of the mapping function is larger, the sensing data estimation error, Δx, is lower for the same the same magnitude of starting frequency estimation error, Δf₀. Therefore, a non-linear mapping function can be customized to prioritize some intervals of the sensing data, x. The prioritized intervals may be considered to be of greater importance than non-prioritized intervals based on an application to which the sensing data, x, relates. For example, if the accuracy of the sensing data, x, is more important in a specific interval, a non-linear mapping function may be selected that has a larger slope (derivative) in the specific interval. According to another example, if it is known that most of the values of the sensing data, x, will be in a certain interval, the non-linear mapping function may be designed to have a larger slope in the certain interval. It follows that prior knowledge about the sensing data, x, can help when optimizing a mapping function.

Aspects of the present application relate to low latency accurate positioning. Recall that, when estimating a position of an RX node, range measurements and angle measurements, obtained at the RX node, may be used in conjunction with information about the position of the TX node. Several applications are known to make use of the position of the RX node at the RX node. However, in the current state of the art, the RX node is able to obtain the measurements but is unable to obtain position information for the TX node. It follows that, in typical scenarios, the RX node generally transmits the measurements to a central network node, such as the SMF 176, where position information for the TX node is available. The SMF 176, or similar network node, may determine position information for the RX node and transmit, to the RX node, the position information for the RX node.

This exchange may be shown to be a source of latency and power consumption. The main reason for having this exchange is that position information for the TX node is used when determining position information for the RX node but the RX node does not have position information for the TX node. Using aspects of the present application, for example, those aspects described in conjunction with a description of FIG. 7 and FIG. 13, the TX 702 may embed position information, for the TX 702, in the first sensing signal. The RX 704 may extract the position information from the first sensing signal. The extracted position information may be shown to allow the RX 704 to determine position information for the RX 704 without an exchange of messages with a network node, such as the SMF 176. Accordingly, positioning service latency may be shown to be reduced along with a reduction in power consumption. Additionally, since an analog mapping function is employed, the RX 704 may be shown to be able to extract a relatively high precision version of the position information for the TX 702. It follows that the position information for the RX 704, determined based on range measurements, angle measurements and the information about the position of the TX 702, may be obtained with appropriate accuracy.

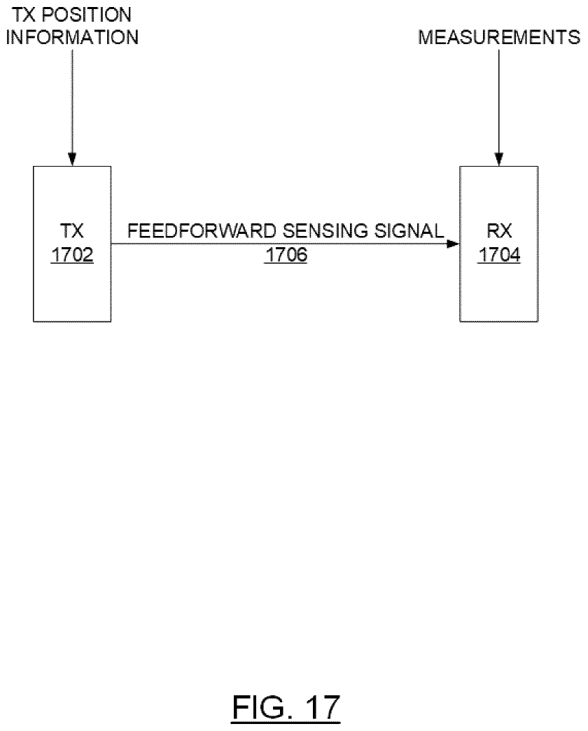

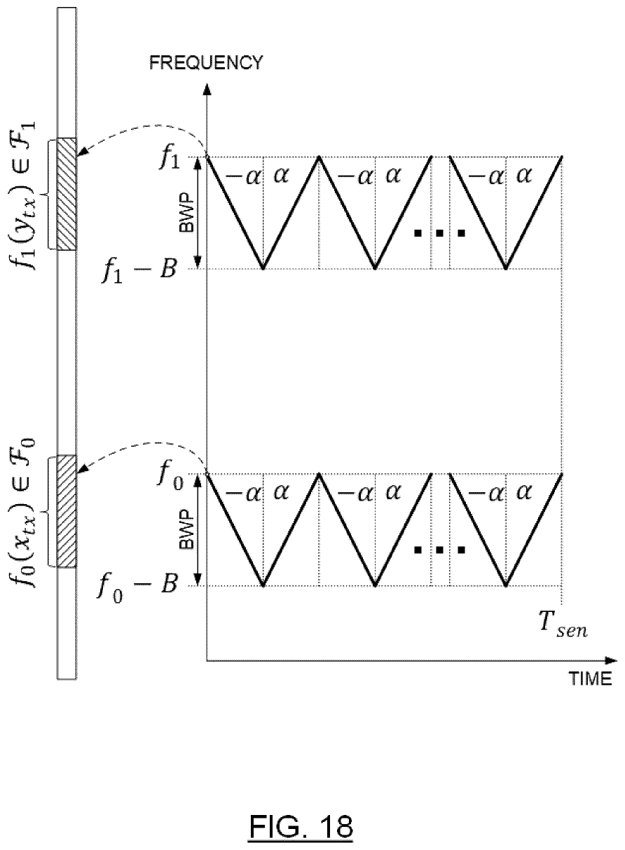

FIG. 17 illustrates a TX 1702 and an RX 1704. More particularly, FIG. 17 illustrates communication related to a scenario for low-latency RX positioning. Notably, the scenario illustrated in FIG. 17 may be considered to be a special case of the scenario illustrated in FIG. 7. In the scenario illustrated in FIG. 17, the TX 1702 is illustrated as having TX positioning information. The TX positioning information may be represented as a position pair, (xₜₓ,yₜₓ), with and x-component, xₜₓ, and a y-component, yₜₓ. In the scenario illustrated in FIG. 17, the TX 1702 is illustrated as transmitting a first sensing signal 1706 to the RX 1704. According to aspects of the present application, the first sensing signal 1706 may include two triangular waveforms, such as the two triangular waveforms illustrated in FIG. 18.

A first analog mapping, f₀(xₜₓ), may be defined to map a value of the x-component, xₜₓ, to a first starting frequency, f₀, of a first triangular waveform illustrated in FIG. 18. Mathematically, xₜₓϵ [symbol] →f₀(xₜₓ)ϵ [symbol] ₀, where [symbol] represents a domain of x-components, xₜₓ, and [symbol] ₀ represents a range of the starting frequency, f₀.

A second analog mapping, f₁(yₜₓ), may be defined to map a value of the y-component, yₜₓ, to a second starting frequency, f₁, of a second triangular waveform illustrated in FIG. 18. Mathematically, yₜₓϵ [symbol] →f₁(yₜₓ)ϵ [symbol] ₁, where [symbol] represents a domain of y-components, yₜₓ, and [symbol] ₁ represents a range of the starting frequency, f₁.

Through the use of the two triangular waveforms illustrated in FIG. 18, the TX 1702 may embed the x-component and the y-component of the position pair that is representative of the position the TX 1702. In particular, the TX 1702 may embed the two components of the position pair in the respective starting frequencies, f₀ and f₁, of the two triangular waveforms.

At the TX 1702, the first starting frequency, f₀, may be determined from a linear mapping function with a format f₀(xₜₓ)=axₜₓ+b.

At the TX 1702, the second starting frequency, f₁, may be determined from a linear mapping function with a format f₁(yₜₓ)=cyₜₓ+d.

At the RX 1704, an estimate,

$${f}_{0}^{′} ,$$

may be obtained for the first starting frequency. Subsequently, an estimate,

$${x}_{tx}^{′} ,$$

for the x-component may be obtained from a relationship arranged as

$${x}_{tx}^{′} = \frac{{f}_{0}^{′} - b}{a} .$$

At the RX 1704, an estimate,

$${f}_{1}^{′} ,$$

may be obtained for the second starting frequency Subsequently, an estimate,

$${y}_{tx}^{′} ,$$

for the y-component may be obtained from a relationship arranged as

$${y}_{tx}^{′} = \frac{{f}_{1}^{′} - d}{c} .$$

At the RX 1704, an estimate,

It is notable that in this one example, a first signal is used to transmit first sensing data, xₜₓ, and a second signal, separate from the first signal, is used to transmit second sensing data, yₜₓ. It should be clear that a separate signal need not be transmitted for every single sensing data. In another approach, different parameters may be embedded in the starting frequency of each chirp signal among a plurality of chirp signals in an overall chirp-based RF signal. This approach may be shown to reduce overhead. However, the reduction in overhead may be shown to come at a cost of a more complicated estimation process.

Aspects of the present application relate to a backscattering communication mode. Using aspects of the present application, for example, those aspects described in conjunction with a description of FIG. 6, the RX 604 may use measurement information to manipulate the first sensing signal 606 in an analog fashion (such as to add a frequency shift) and reflect the manipulated first sensing signal as the second sensing signal 608. This analog manipulation may be shown to enable the RX 604 to save power, relative to transmitting a second sensing signal (see step 1210, FIG. 12). Instead of transmitting a second sensing signal, the RX 604 merely reflects the first sensing signal 606 with some manipulation, wherein aspects of the manipulation have been determined through a mapping to obtained measurements. It may be shown that active transmitting is much more power consuming than passive reflection.

The SMF 176 may define an analog mapping from the domain of measurement values (such as range or angle of arrival) to the domain of frequency shift.

The SMF 176 may share, through signaling, the defined analog mapping with the TX 602 and the RX 604. The sharing can happen only once or once in a while.

The TX 602 transmits a first sensing signal 606. The first sensing signal 606 may be implemented as a typical sensing signal, which is only meant to be used, at the RX 604, to perform sensing measurements, i.e., the first sensing signal 606 is not configured to carry sensing data.

Upon receiving the first sensing signal, the RX 604 obtains measurement values.

Using the obtained measurements values and the analog mapping received from the SMF 176, the RX 604 obtains a frequency shift.

Instead of generating a new signal, the RX 604 merely manipulates the incoming first sensing signal 606 by applying the obtained frequency shift and reflects the manipulated signal. The reflected manipulated signal may be considered as the second sensing signal 608. In some embodiments, reflecting the manipulated signal may be performed by RF relaying or RF looping by RX 604.

Upon receiving the second sensing signal 608, the TX 602 may perform measurement to obtain an estimated applied frequency shift.

The TX 602 may then apply an inverse of the analog mapping to extract, from the estimated frequency shift, the measurement values with relatively high precision.

The TX 602 may then use the extracted measurement values, along with side information available at the TX 602, to perform sensing parameter estimation.

Aspects of the present application relate to signaling that may be used to facilitate other aspects of the present application.

It has been discussed hereinbefore that chirp-based RF signal configurations may be defined to include parameters such as chirp rate and sensing time.

Generally, there are two possibilities. In a first possibility, the configuration parameters are fixed. In the first possibility, there is no need for signaling to send the configuration parameters to the TX and the RX. In a second possibility, the configuration parameters are tunable and should be set. In the second possibility, there is need for the network (say, the SMF 176) to set the configuration parameters and then signal the configuration parameters to the TX and the RX. Note that it is also possible that some of the configuration parameters are fixed and some configuration parameters are tunable. In that case, signaling may be used to share the tunable configuration parameters. The SMF 176 may share configuration parameters when sharing the analog mapping (see step 1201, FIG. 12 and step 1301, FIG. 13).

Aspects of the present application provide a general scheme.

Consider a scenario in which a first node is to transmit, to a second node, discrete-valued sensing data, y, in addition to continuous-valued sensing data, x. A practically popular example of discrete-valued sensing data, y, is a node identity, which belongs to a set of limited number of discrete values. To this point in the present application, there has been a focus on transmission of continuous-valued sensing data. In the presently considered scenario, aspects of the present application may be generalized to allow for the transmission of both discrete-valued sensing data, y, in addition to continuous-valued sensing data, x. To this end, a two-level hierarchical scheme may be employed. In the two-level hierarchical scheme, discrete-valued sensing data, y, is considered at one level and continuous-valued sensing data, x, is considered at another level.

It is expected that the set of values available for the discrete-valued sensing data, y, will have a given number, N_{y}, of elements. In the communication channel between the first node and the second node, it may be assumed that there are at least the same number, N_{y}, of non-overlapping frequency sub-bands from among which a starting frequency, f₀, may be selected.

The first node may use a discrete (non-continuous) mapping to select one of the non-overlapping frequency sub-band on the basis of the value of the discrete-valued sensing data, y. Once the first node has determined a selected sub-band, the first node may use a continuous mapping to obtain a starting frequency, f₀, on the basis of the value for the continuous sensing data, x.

It follows that the first node applies the starting frequency, f₀, once obtained, to the generation of a chirp-based RF sensing signal. The first node may then transmit the chirp-based RF sensing signal. Upon receiving the chirp-based RF sensing signal, the second node may obtain an estimate,

$${f}_{0}^{′} ,$$

of the starting frequency. The second node may then determine the frequency sub-band to which the starting frequency estimate,

$${f}_{0}^{′} ,$$

belongs. There is only one sub-band to which the starting frequency estimate,

$${f}_{0}^{′} ,$$

may belong, since the sub-bands are non-overlapping. The determined sub-band may be shown to provide the second node with a value of the discrete sensing data, y.

Subsequently, the second node may determine a value for the continuous sensing data, x, by applying, to the starting frequency estimate,

$${f}_{0}^{′} ,$$

an inverse of the continuous mapping.

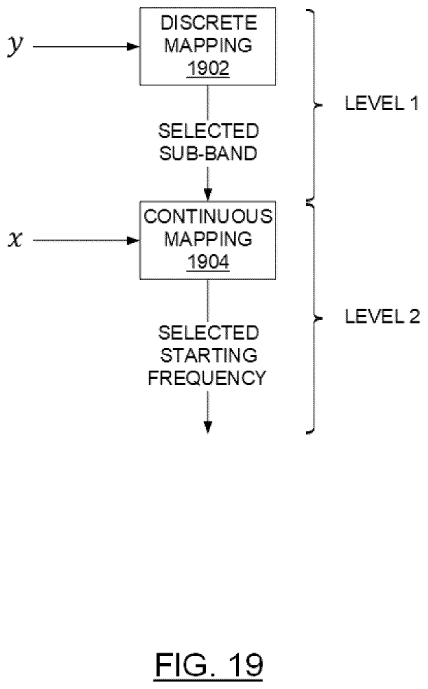

FIG. 19 illustrates a graphical representation of a two-level hierarchical mapping scheme in accordance with aspects of the present application. The graphical representation of FIG. 19 includes a discrete mapping 1902 and a continuous mapping 1904. The discrete mapping 1902 is in a first level of the two-level hierarchical mapping scheme. The continuous mapping 1904 is in a second level of the two-level hierarchical mapping scheme.

In operation, the discrete mapping 1902 receives, as input, discrete-valued sensing data, y, and produces, as output, an indication of a selected sub-band. The continuous mapping 1904 receives, as input, the indication of the selected sub-band and continuous-valued sensing data, x, and produces, as output, an indication of a selected starting frequency.

Notably, in the hierarchical scheme illustrated in FIG. 19, the continuous mapping 1904 can be applied in the same manner for each of various frequency sub-bands available for selection by the discrete mapping 1902. Alternatively, the continuous mapping 1904 can be applied in a distinct manner for each of various frequency sub-bands available for selection by the discrete mapping 1902.

Furthermore, it is notable that a hierarchical mapping scheme need not be limited to two levels. Indeed, a hierarchical mapping scheme with more than two levels may be understood to be able to convey more information than a hierarchical mapping scheme with only two levels. For example, discrete-valued sensing data in a discrete sensing data set that has a number, M, of elements, {y₁, y₂, . . . , y_{M}}, may be conveyed using a hierarchical mapping scheme with M+1 levels. In a hierarchical mapping scheme with M+1 levels, M levels may be used to map the elements of discrete-valued sensing data, {y₁, y₂, . . . , y_{M}}, and the last level may be used to map the value of continuous sensing data, x.

When using such hierarchical structure, both nodes (TX and RX) should be aware of the mappings. It follows that a signaling exchange may be implemented to inform both nodes about the discrete mapping and the continuous mapping.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, from a transmitter, a linearly frequency modulated (LFM) radio frequency (RF) first sensing signal;
obtaining, by performing measurements of the LFM RF first sensing signal, a plurality of measurement results;
processing the plurality of measurement results to obtain an estimate of a first sensing signal starting frequency of the LFM RF first sensing signal;
extracting estimated side information by providing the estimate of the first sensing signal starting frequency as an input to an inverse of a continuous mapping of side information to starting frequencies; and
estimating, based on the estimated side information and the plurality of measurement results, sensing parameters.

2. The method of claim 1, further comprising receiving the continuous mapping.

3. The method of claim 1, further comprising receiving an indication of a type for the estimated side information.

4. The method of claim 1, wherein the estimated side information indicates a first coordinate of a location of the transmitter.

5. The method of claim 4, wherein the estimated side information indicates a second coordinate of the location of the transmitter.

6. The method of claim 1, wherein the continuous mapping comprises a linear function.

7. The method of claim 1, wherein the continuous mapping comprises a non-linear function.

8. An apparatus comprising:
at least one processor; and
a memory storing instructions that, when executed by the at least one processor, cause the apparatus to perform:
receiving, from a transmitter, a linearly frequency modulated (LFM) radio frequency (RF) first sensing signal;
obtaining, by performing measurements of the LFM RF first sensing signal, a plurality of measurement results;
processing the plurality of measurement results to obtain an estimate of a first sensing signal starting frequency of the LFM RF first sensing signal;
extracting estimated side information by providing the estimate of the first sensing signal starting frequency as an input to an inverse of a continuous mapping of side information to starting frequencies; and
estimating, based on the estimated side information and the plurality of measurement results, sensing parameters.

9. The apparatus of claim 8, the instructions, when executed by the at least one processor, further cause the apparatus to perform receiving the continuous mapping.

10. The apparatus of claim 8, the instructions, when executed by the at least one processor, further cause the apparatus to perform receiving an indication of a type for the estimated side information.

11. The apparatus of claim 8, wherein the estimated side information indicates a first coordinate of a location of the transmitter.

12. The apparatus of claim 11, wherein the estimated side information indicates a second coordinate of the location of the transmitter.

13. The apparatus of claim 8, wherein the continuous mapping comprises a linear function.

14. The apparatus of claim 8, wherein the continuous mapping comprises a non-linear function.

15. A non-transitory computer-readable medium comprising instructions that, when executed by an apparatus, cause the apparatus to perform:
receiving, from a transmitter, a linearly frequency modulated (LFM) radio frequency (RF) first sensing signal;
obtaining, by performing measurements of the LFM RF first sensing signal, a plurality of measurement results;
processing the plurality of measurement results to obtain an estimate of a first sensing signal starting frequency of the LFM RF first sensing signal;
extracting estimated side information by providing the estimate of the first sensing signal starting frequency as an input to an inverse of a continuous mapping of side information to starting frequencies; and
estimating, based on the estimated side information and the plurality of measurement results, sensing parameters.

16. The non-transitory computer-readable medium of claim 15, the instructions, when executed by the apparatus, further cause the apparatus to perform receiving the continuous mapping.

17. The non-transitory computer-readable medium of claim 15, the instructions, when executed by the apparatus, further cause the apparatus to perform receiving an indication of a type for the estimated side information.

18. The non-transitory computer-readable medium of claim 15, wherein the estimated side information indicates a first coordinate of a location of the transmitter.

19. The non-transitory computer-readable medium of claim 15, wherein the continuous mapping comprises a linear function.

20. The non-transitory computer-readable medium of claim 15, wherein the continuous mapping comprises a non-linear function.
